(19) United States
(12) Patent Application Publication
(10) Pub. No.: US 2025/0124279 A1
(43) Pub. Date: Apr. 17, 2025

(54) TRAINING A TIME-SERIES-LANGUAGE MODEL ADAPTED FOR DOMAIN-SPECIFIC TASKS

(71) Applicant: NEC Laboratories America, Inc., Princeton, NJ (US)

(72) Inventors: Yuncong Chen, Jersey City, NJ (US); Wenchao Yu, Plainsboro, NJ (US); Wei Cheng, Princeton Junction, NJ (US); Yanchi Liu, Princeton, NJ (US); Haifeng Chen, West Windsor, NJ (US); Zhengzhang Chen, Princeton Junction, NJ (US); LuAn Tang, Cranbury, NJ (US); Liri Fang, Monmouth Junction, NJ (US)

(21) Appl. No.: 18/889,610

(22) Filed: Sep. 19, 2024

Related U.S. Application Data
(60) Provisional application No. 63/543,541, filed on Oct. 11, 2023.

(51) Int. Cl. G06N 3/08; G06N 3/0455

(52) U.S. Cl. CPC G06N 3/08; G06N 3/0455

(57) ABSTRACT

Systems and methods for training a time-series-language (TSLa) model adapted for domain-specific tasks. An encoder-decoder neural network can be trained to tokenize time-series data to obtain a discrete-to-language embedding space. The TSLa model can learn a linear mapping function by concatenating token embeddings from the discrete-to-language embedding space with positional encoding to obtain mixed-modality token sequences. Token augmentation can transform the tokens from the mixed-modality token sequences with to obtain augmented tokens. The augmented tokens can train the TSLa model using a computed token likelihood to predict next tokens for the mixed-modality token sequences to obtain a trained TSLa model. A domain-specific dataset can fine-tune the trained TSLa model to adapt the trained TSLa model to perform a domain-specific task.

### RELATED APPLICATION INFORMATION

This application claims priority to U.S. Provisional App. No. 63/543,541, filed on Oct. 11, 2023, incorporated herein by reference in its entirety.

### BACKGROUND

### Technical Field

The present invention relates to training neural networks for domain-specific tasks and more particularly to training a time-series-language model adapted for domain specific tasks.

### Description of the Related Art

Artificial intelligence models have been developed to understand time-series data which are data points collected or recorded at specific time intervals. Additionally, there has been immense progress in the development of natural language processing models. However, these singular modality focused models are limited to the modality that they are trained with.

### SUMMARY

According to an aspect of the present invention, a computer-implemented method is provided for training a time-series-language (TSLa) model adapted for domain-specific tasks, including, training an encoder-decoder neural network to tokenize time-series data to obtain a discrete-to-language embedding space, learning, by the TSLa model, a linear mapping function by concatenating token embeddings from the discrete-to-language embedding space with positional encoding to obtain mixed-modality token sequences, transforming the tokens from the mixed-modality token sequences with token augmentation to obtain augmented tokens, training the TSLa model with the augmented tokens using a computed token likelihood to predict next tokens for the mixed-modality token sequences to obtain a trained TSLa model, and fine-tuning the trained TSLa model with a domain-specific dataset to adapt the trained TSLa model to perform a domain-specific task.

According to another aspect of the present invention, a system is provided for training a time-series-language (TSLa) model adapted for domain-specific tasks, including, a memory device, one or more processor devices operatively coupled with the memory device to cause one or more processor devices to train an encoder-decoder neural network to tokenize time-series data to obtain a discrete-to-language embedding space, learn, by the TSLa model, a linear mapping function by concatenating token embeddings from the discrete-to-language embedding space with positional encoding to obtain mixed-modality token sequences, transform the tokens from the mixed-modality token sequences with token augmentation to obtain augmented tokens, train the TSLa model with the augmented tokens using a computed token likelihood to predict next tokens for the mixed-modality token sequences, and fine-tune the TSLa model with a domain-specific dataset to adapt the TSLa model to perform a domain-specific task.

According to yet another aspect of the present invention, a non-transitory computer program product is provided including a computer-readable storage medium having program code for training a time-series-language (TSLa) model adapted for domain-specific tasks, wherein the program code when executed on a computer causes the computer to train an encoder-decoder neural network to tokenize time-series data to obtain a discrete-to-language embedding space, learn, by the TSLa model, a linear mapping function by concatenating token embeddings from the discrete-to-language embedding space with positional encoding to obtain mixed-modality token sequences, transform the tokens from the mixed-modality token sequences with token augmentation to obtain augmented tokens, train the TSLa model with the augmented tokens using a computed token likelihood to predict next tokens for the mixed-modality token sequences, and fine-tune the TSLa model with a domain-specific dataset to adapt the TSLa model to perform a domain-specific task.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a flow diagram illustrating a high-level method for training a time-series-language model adapted for domain-specific tasks, in accordance with an embodiment of the present invention;

FIG. 2 is a block diagram illustrating a method for training a time-series tokenizer for the time-series-language model, in accordance with an embodiment of the present invention;

FIG. 3 is a block diagram illustrating a method for training the time-series-language model, in accordance with an embodiment of the present invention;

FIG. 4 is a flow diagram illustrating a system for training a time-series-language model adapted for domain-specific tasks, in accordance with an embodiment of the present invention;

FIG. 5 is a flow diagram illustrating a system for implementing practical applications for training a time-series-language model adapted for domain-specific tasks, in accordance with an embodiment of the present invention; and

FIG. 6 is a block diagram illustrating deep neural networks for training a time-series-language model adapted for domain-specific tasks, in accordance with an embodiment of the present invention.

### DETAILED DESCRIPTION OF PREFERRED EMBODIMENTS

In accordance with embodiments of the present invention, systems and methods are provided for training a time-series-language (TSLa) model adapted for domain-specific tasks.

In an embodiment, a TSLa model can be trained and adapted for domain specific tasks. To train the TSLa model, time-series data can train a time-series tokenizer to obtain a discrete-to-language embedding space. The TSLa model can learn a linear mapping function by concatenating token embeddings from the discrete-to-language embedding space with positional encoding to obtain mixed-modality token sequences. The TSLa model can transform the tokens from the mixed-modality token sequences with token augmentation to obtain augmented tokens. A token likelihood computed from augmented tokens can train the TSLa model to predict next tokens for the mixed modality token sequence to obtain a trained TSLa model. A domain-specific dataset can fine-tune the trained TSLa model to adapt the trained TSLa model to a domain-specific task.

The trained TSLa model can generate predicted time-series data using the trained TSLa model based on a dataset and a text instruction. In another embodiment, the trained TSLa model can transform time-series data using the trained TSLa model based on a dataset and a text instruction.

Time series data is ubiquitous in various real-world domains such as finance, healthcare, weather, physical sensing, and energy management. Other models, such as time-series captioning models and time-series generation models, have been conducted from a time series perspective but fail to recognize the profound connection between time series and natural language. In many time-series-related domains, there exists a need for domain experts to interpret time-series data using natural language.

The present embodiments can train the TSLa model to jointly learn time-series data and text data to interpret time-series data using natural language, a task other time-series models cannot perform. By doing so, the present embodiments improve data efficiency of time-series and language models.

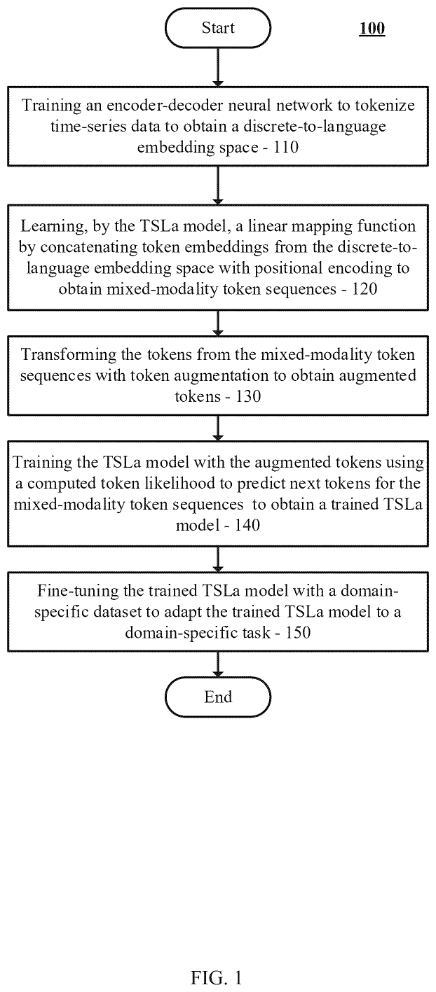

Referring now in detail to the figures in which like numerals represent the same or similar elements and initially to FIG. 1, a high-level overview of a computer-implemented method for training a time-series-language (TSLa) model adapted for domain-specific tasks is illustratively depicted in accordance with one embodiment of the present invention.

In an embodiment, a time-series-language (TSLa) model can be trained and adapted for domain specific tasks. To train the TSLa model, time-series data can train a time-series tokenizer to obtain a discrete-to-language embedding space. The TSLa model can learn a linear mapping function by concatenating token embeddings from the discrete-to-language embedding space with positional encoding to obtain mixed-modality token sequences. The TSLa model can transform the tokens from the mixed-modality token sequences with token augmentation to obtain augmented tokens. A token likelihood computed from augmented tokens can train the TSLa model to predict next tokens for the mixed modality token sequence to obtain a trained TSLa model. A domain-specific dataset can fine-tune the trained TSLa model to adapt the trained TSLa model to a domain-specific task.

The trained TSLa model can generate predicted time-series data using the trained TSLa model based on a dataset and a text instruction. In another embodiment, the trained TSLa model can transform time-series data using the trained TSLa model based on a dataset and a text instruction.

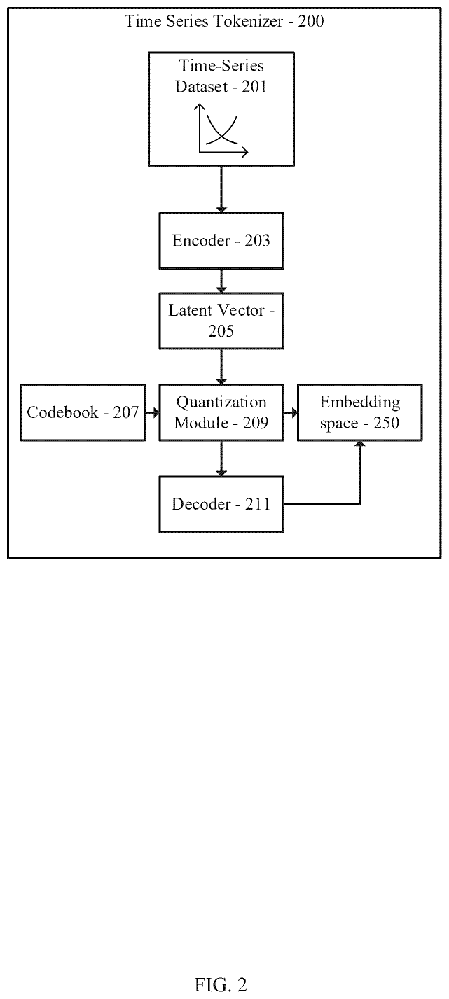

Referring now to block 110 of FIG. 1 which describes an embodiment where time-series data can train an encoder-decoder neural network, to tokenize time-series data and obtain a discrete-to-language embedding space. The process described in block 110 of FIG. 1 is further described in FIG. 2.

Referring now to FIG. 2 which describes a block diagram for training the time-series tokenizer in accordance with an embodiment of the present invention.

Using a time-series dataset 201, the entire network is trained to embed each input time series sample from the time-series dataset 201 into one vector (e.g., embedding space 250) in a codebook 207 using an encoder 203 and a quantization module 209, and then reconstruct the input time series from the vector using a decoder.

In an embodiment, the time-series data 201 can be unannotated. In another embodiment, the time-series data 201 can be annotated. For example, given a yoga demonstration video with narration by a coach, the present embodiments can detect the key points of the body as she performs a specific maneuver using computer vision models, and then the coordinates of the key points over time constitute a multivariate time series data. The transcribed narration texts can be used as annotation of different windows of the time-series. Similar data can be found in domains of industry monitoring (equipment sensor readings and inspection reports), and healthcare (physiological test results and diagnosis document).

In an embodiment, the time-series tokenizer 200 can include an encoder network 203, a decoder network 211 and a codebook 207 that consists of a fixed number of latent vectors. The quantization module 209 (e.g., quantizer) uses the nearest neighbor algorithm, returning the vector in the codebook 207 that is closest to the input vector.

To train the time-series tokenizer 200, the time-series tokenizer 200 can segment the time series input X into patches Xseg by a segmentation length Lseg, which aims to capture the correlation of time series within Lseg and compress the patch into the continuous embedding space by the encoder layer Enc(Xseg). A Quantization module 209 can map the encoder 203 output to the nearest discrete embedding (vₖ) as follows: Quantizer(z=k|x)=vₖ, where k=argminⱼ∥Enc(x)−vⱼj∥₂, x is the time-series input.

Then, a decoder 211 Dec(v) reconstructs the time series Xseg based on the discrete embeddings.

The encoder 203 and decoder 211 of time-series tokenizer 200 can take various architectures. In an embodiment, a transformer-based neural network can be employed.

The training objective of the time-series tokenizer can be formulated as:

$$L = log p ( x \vert Dec ( {v}_{k} ) ) + {‖ sg [ Enc ( x ) ] - {v}_{k} ‖}_{2}^{2} + β {‖ Enc ( x ) * sg [ {v}_{k} ] ‖}_{2}^{2}$$

The encoder-decoder framework of the time-series tokenizer 200 is trained by the reconstruction loss log p(x|Dec(vₖ)). The discrete embedding space (vₖ) 250 is regularized by the l2 loss, ∥sg[Enc(x)]−vₖ∥₂². This aims to halt the gradient (i.e., sg[·]) of the encoder output of time-series data x [Enc(x)] and enforce the embedding space (vₖ) 250 to the encoder output. The third term β∥Enc(x)−sg[vₖ]∥₂² aims to regularize the encoder output to be committed to the current embedding space (vₖ) 250 and to align the parameter updates represented by (β) with the embedding space (vₖ) 250.

Then, the learned discrete tokens Vₜₛ can be considered the vocabulary of time series and can be integrated with the textual vocabulary Vₜₑₓₜ of the pre-trained language model, as a unified vocabulary V=Vₜₛ∪Vₜₑₓₜ. The unified vocabulary can be employed to train the TSLa model.

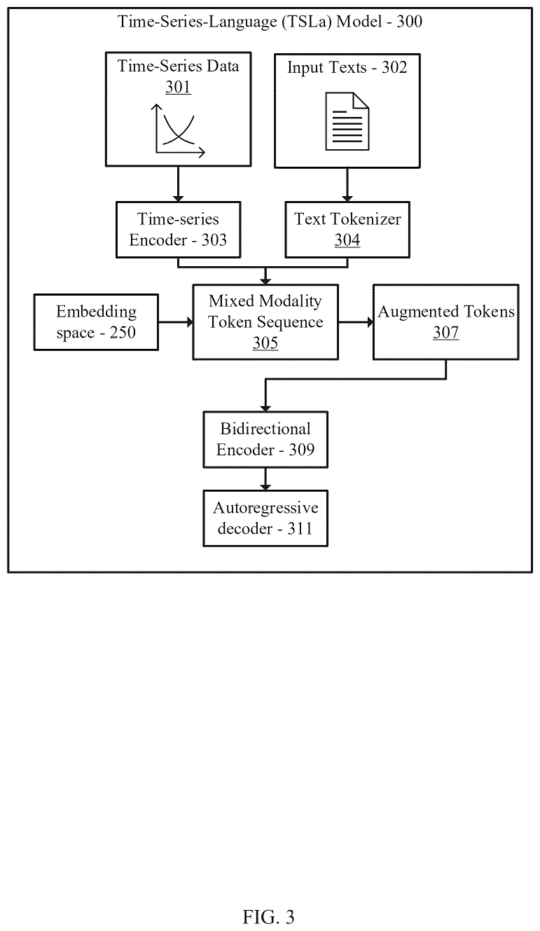

Referring back now to block 120 of FIG. 1 which describes an embodiment where the TSLa model can learn a linear mapping function from the discrete-to-language embedding space. The process described in block 120 of FIG. 1 is further described in FIG. 3.

Referring now to FIG. 3 which describes a block diagram for training the TSLa model, in accordance with an embodiment of the present invention.

The TSLa model 300 can employ an encoder-decoder framework. In an embodiment, the time series-language model 300 can employ a transformer language model. The bidirectional encoder 309 can be a multi-layer bidirectional Transformer encoder. The autoregressive decoder 311 can be a left-to-right autoregressive decoder performing cross-attention over the final hidden output of the encoder. In another embodiment uses a pretrained decoder-only language model (GPT-2™) as the base model. The present embodiments can formulate the linear mapping function as

v=m(v)=v^{T}Wₜₛ, where Wₜₛ∈ [symbol] ^{d}^{ᵥ}^{×d}^{ₑ}, dᵥ represents the embedding dimension of time series discrete embedding vector v, dₑ denotes the dimension of the language model embedding layer, [symbol] is a set of real numbers, m is a mapping function, and Wₜₛ is the linear transformation of the time-series embedding matrix.

The TSLa model can obtain mixed-modality token sequences 305 by concatenating token embeddings from the discrete-to-language embedding space 250 with positional encoding. The mixed modality token sequence 305 can include the following sequence “[BOT]<text tokens>[EOT][BOS]<time series tokens>[EOS],” where “[BOT],” “[EOT],” “[BOS],” and “[EOS]” are special tokens that mark the boundaries of each span. BOT marks the beginning of the text token and EOT marks the end of the text token. BOS marks the beginning of the time-series token and EOS marks the end of the time-series token. The order of the text token span and time-series token spans are interchangeable.

Referring back now to block 130 of FIG. 1 which describes an embodiment where the TSLa model can transform tokens from the mixed-modality token sequences with token augmentation to obtain augmented tokens. The process described in block 130 of FIG. 1 is further described in FIG. 3 which describes a block diagram for training the TSLa model, in accordance with an embodiment of the present invention.

During the training of the TSLa model 300, the present embodiments employ token augmentation to obtain augmented tokens 307 and enforce denoising capabilities on time-series spans and mixed modality spans. This improves the accuracy of the TSLa model, and also enables the TSLa model to handle corrupted or incomplete data.

The token augmentation strategies can include token masking, token deletion, token infilling, and token rotation. Token masking can include random masking of tokens by replacing them with the special token such as “[mask].” Token deletion can include random removal of selected tokens from the sequence. Token infilling can include sampling token spans of a certain length from a Poisson distribution and replacing these sampled spans with a single “[mask]” token. Token rotation can include reordering the time series sequence and the text token sequence.

Referring now to block 140 which describes an embodiment where a computed token likelihood computed with the augmented tokens can train the TSLa model to predict next tokens for the mixed modality token sequence. The token likelihood can be computed as:

[symbol] (t₁, t₂, . . . )=πᵢ( [symbol] (t₁|t₁ . . . tᵢ₋₁), where tᵢ denotes the ith token where i an element of the total number of tokens, and [symbol] is the probability of the token occurring in a given mixed modality token sequence.

Block 150 describes an embodiment where a domain-specific dataset can fine-tune the TSLa model to adapt the TSLa model to a domain specific task.

In an embodiment, multiple domain-specific tasks can fine-tune the TSLa with instruction templates. The instruction templates for domain-specific tasks can be generated using a task instruction and corresponding modality input. These task instruction can include time series captioning, time series question answering, time-based time series generation, and text-based time-series continuation. These task instructions can have input data in various modalities. For instance, time series captioning and text-based time series synthesis may involve a single modality (e.g., time-series data and text data respectively) input, while others, such as time series question answering and text-based time series continuation, can incorporate multiple modalities (e.g. time-series data and text data) into their input data.

The task instruction can be a series of text that describes the action that the TSLa model is instructed to do. For example, for time-series captioning the task instruction can include “Produce a descriptive caption for the displayed time series data. \n\n<time-series data>.”

To fine-tune the TSLa model using the multiple domain-tasks, the corresponding datasets for the domain tasks is mixed in a single data set where the task is specified by an additional language field such as “instruction.” Small metric updates through low-rank decomposition of matrices can fine-tune a frozen trained TSLa model.

The present embodiments can train the TSLa model to jointly learn time-series data and text data to interpret time-series data using natural language, a task other time-series models cannot perform. By doing so, the present embodiments improve data efficiency of time-series and language models.

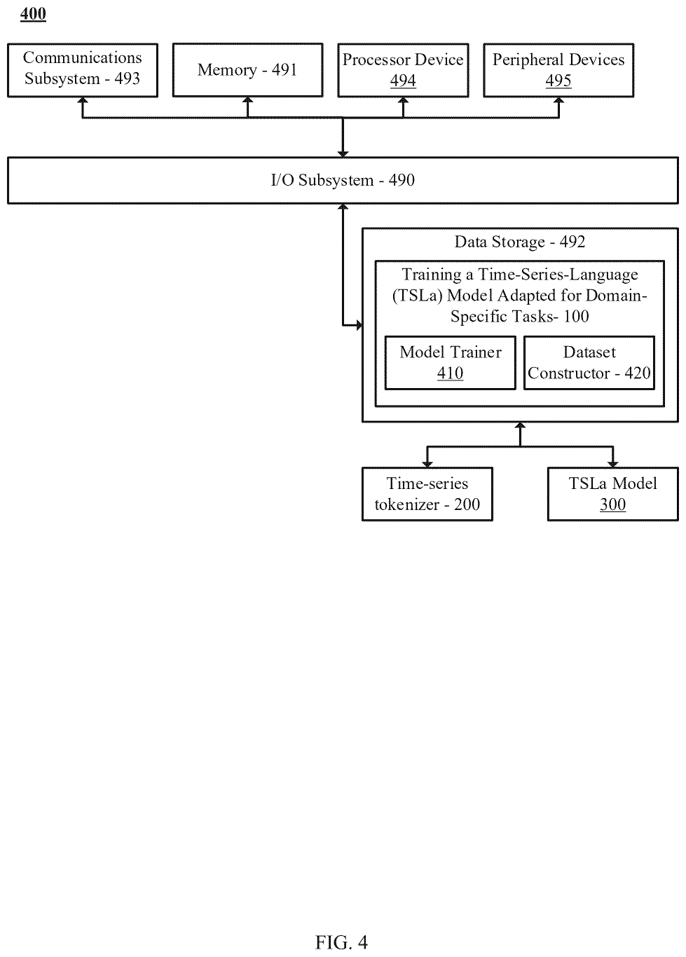

Referring now to FIG. 4, a system for training a time-series-language (TSLa) model adapted for domain-specific tasks is illustratively depicted in accordance with an embodiment of the present invention.

The computing device 400 illustratively includes the processor device 494, an input/output (I/O) subsystem 490, a memory 491, a data storage device 492, and a communication subsystem 493, and/or other components and devices commonly found in a server or similar computing device. The computing device 400 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 491, or portions thereof, may be incorporated in the processor device 494 in some embodiments.

The processor device 494 may be embodied as any type of processor capable of performing the functions described herein. The processor device 494 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 491 may be embodied as any type of volatile or non-volatile memory or data storage capable of performing the functions described herein. In operation, the memory 491 may store various data and software employed during operation of the computing device 400, such as operating systems, applications, programs, libraries, and drivers. The memory 491 is communicatively coupled to the processor device 494 via the I/O subsystem 490, which may be embodied as circuitry and/or components to facilitate input/output operations with the processor device 494, the memory 491, and other components of the computing device 400. For example, the I/O subsystem 490 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 490 may form a portion of a system-on-a-chip (SOC) and be incorporated, along with the processor device 494, the memory 491, and other components of the computing device 400, on a single integrated circuit chip.

The data storage device 492 may be embodied as any type of device or devices configured for short-term or long-term storage of data such as, for example, memory devices and circuits, memory cards, hard disk drives, solid state drives, or other data storage devices. The data storage device 492 can store program code for training a time-series-language model adapted for domain-specific tasks 100. The program code for training a time-series-language model adapted for domain-specific tasks 100 can include a model trainer 410 that can train artificial intelligence models with datasets. The program code for training a time-series-language model adapted for domain-specific tasks 100 can include a dataset constructor 420 that can construct a training dataset from inputs provided such as documents, text, existing datasets. The program code for verifying complex sentences with artificial intelligence 100 can fine-tune the TSLa model 300 to adapt the TSLa model 300 to domain-specific tasks. Any or all of these program code blocks may be included in a given computing system.

The communication subsystem 493 of the computing device 400 may be embodied as any network interface controller or other communication circuit, device, or collection thereof, capable of enabling communications between the computing device 400 and other remote devices over a network. The communication subsystem 493 may be configured to employ any one or more communication technology (e.g., wired or wireless communications) and associated protocols (e.g., Ethernet, InfiniBand®, Bluetooth®, Wi-Fi®, WiMAX, etc.) to affect such communication.

As shown, the computing device 400 may also include one or more peripheral devices 495. The peripheral devices 495 may include any number of additional input/output devices, interface devices, and/or other peripheral devices. For example, in some embodiments, the peripheral devices 495 may include a display, touch screen, graphics circuitry, keyboard, mouse, speaker system, microphone, network interface, and/or other input/output devices, interface devices, GPS, camera, and/or other peripheral devices.

Of course, the computing device 400 may also include other elements (not shown), as readily contemplated by one of skill in the art, as well as omit certain elements. For example, various other sensors, input devices, and/or output devices can be included in computing device 400, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing system 400 are readily contemplated by one of ordinary skill in the art given the teachings of the present invention provided herein.

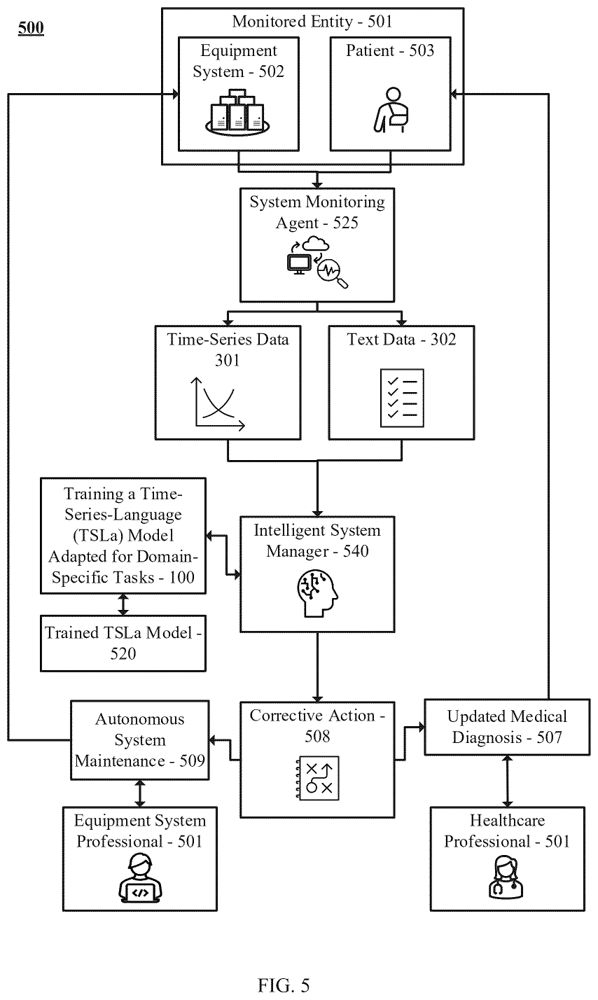

Referring now to FIG. 5, a block diagram illustrating practical applications for training a time-series-language model adapted for downstream tasks, in accordance with an embodiment of the present invention.

In an embodiment, system 500 can monitor a monitored entity 501 with a system monitoring agent 525 which can collect time-series data 301 and text data 302 from the monitored entity 501. The time-series data 301 and text data 302 (e.g., audio, text) can be utilized by an intelligent system manager 540 that can implement training a time-series-language (TSLa) model adapted for domain-specific tasks 100 that can obtain a trained TSLa model 520.

The domain specific tasks can include time-series captioning, time-series editing based on a text instruction, time-series generation based on a text instruction, time-series data generation for motion detection based on a text instruction, time-series data question answering (e.g., answering questions regarding time-series data).

The intelligent system manger 540 can perform a corrective action 508 based on a domain specific task. The corrective action 508 can assist the decision-making process of a decision-making entity.

In an embodiment within a healthcare setting, time-series data 301 (e.g., vital signs, oxygen levels, glucose levels, etc. taken within a time window) and text data 302 (e.g., medical summary reports, doctor prescription, etc.) of healthcare data can be used by the intelligent system manager to perform a corrective action 508 (e.g. domain-specific task) to generate a predicted time-series data based on a text instruction and generate an updated medical diagnosis 507. For example, the text instruction can be “Generate the future glucose level of the patient if the patient continues with a high-sugar diet.” The predicted time-series data can be employed to generate an updated medical diagnosis 507 of the patient to enhance the understanding of the patient regarding its healthcare data and to be outputted to a healthcare professional 501 to assist its decision-making process regarding the medical diagnosis of the patient.

In another embodiment, the corrective action 508 can be transforming time-series data using the TSLa model based on a text instruction. For example, the text instruction can be “modify the glucose level of the patient if the patient changes to a high-protein diet with less carbs.” The transformed time-series data can be employed to generate an updated medical diagnosis 507 of the patient to enhance the understanding of the patient regarding its healthcare data and to be outputted to a healthcare professional 501 to assist its decision-making process regarding the medical diagnosis of the patient.

In another embodiment within the field of equipment monitoring, the intelligent system manager 540 can learn to detect system anomalies based on the time-series data 301 (e.g., signal data, sensor data, etc.) and text data 302 (e.g., audio logs, text logs, text descriptions, etc.) to perform an automated system maintenance 509 (e.g., rerouting of products in the process, stopping an equipment, diverting resources into a different equipment, etc.).

In another embodiment, the automated system maintenance 509 can be based on a task instruction from an equipment system professional 501 to attain flexibility and accuracy of the automated system maintenance 509. For example, the task instruction can be “Stop equipment A if its temperature reaches four hundred degrees Celsius.”

The present embodiments can be implemented in other fields such as legal, education, finance, weather, etc.

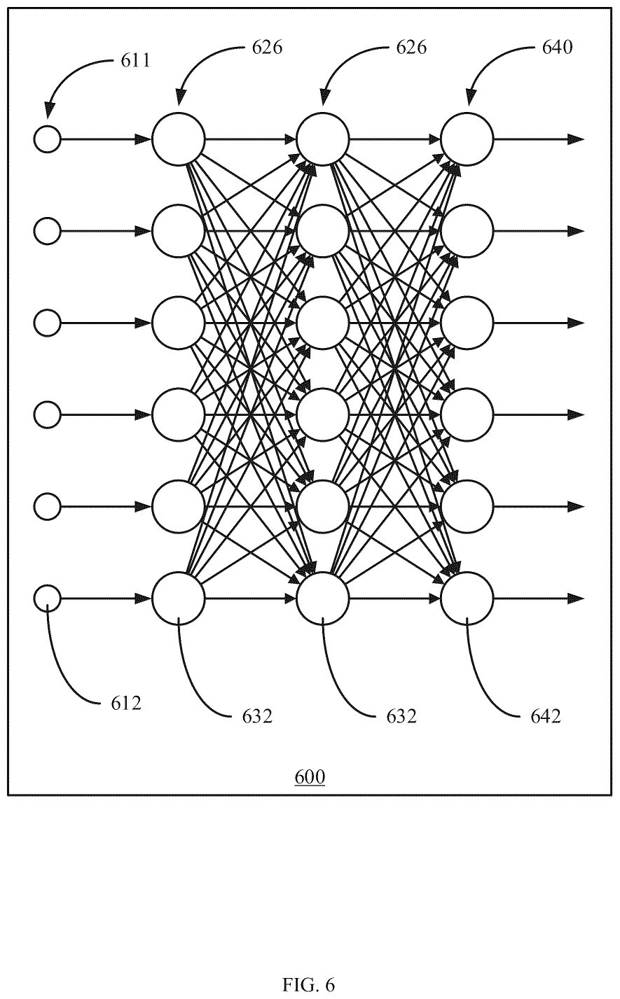

Referring now to FIG. 6, a block diagram illustrating deep learning neural networks for verifying complex sentences with artificial intelligence, in accordance with an embodiment of the present invention.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The deep neural network 600, such as a multilayer perceptron, can have an input layer 611 of source nodes 612, one or more computation layer(s) 626 having one or more computation nodes 632, and an output layer 640, where there is a single output node 642 for each possible category into which the input example can be classified. An input layer 611 can have a number of source nodes 612 equal to the number of data values 612 in the input data 611. The computation nodes 632 in the computation layer(s) 626 can also be referred to as hidden layers, because they are between the source nodes 612 and output node(s) 642 and are not directly observed. Each node 632, 642 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . Wₙ₋₁, Wₙ. The output layer provides the overall response of the network to the inputted data. A deep neural network can be fully connected, where each node in a computational layer is connected to all other nodes in the previous layer, or may have other configurations of connections between layers. If links between nodes are missing, the network is referred to as partially connected.

In an embodiment, the computation layers 626 of the time-series tokenizer 200 can learn the linear mapping of time-series data. The output layer 640 of the time-series tokenizer 200 can then provide the overall response of the network as a likelihood score as discrete embedding space. In an embodiment, the computation layers 626 of the TSLa Model 300 can learn the generic relations between time-series patterns and language tokens from a mixed-modality embedding space. The output layer 640 of the imagination model 440 can then provide the overall response of the network as a prediction of the next token from the mixed modality token sequence.

Training a deep neural network can involve two phases, a forward phase where the weights of each node are fixed and the input propagates through the network, and a backwards phase where an error value is propagated backwards through the network and weight values are updated.

The computation nodes 632 in the one or more computation (hidden) layer(s) 626 perform a nonlinear transformation on the input data 612 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid-state memory, magnetic tape, a removable computer diskette, a random-access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for training a time-series-language (TSLa) model adapted for domain-specific tasks, comprising:
training an encoder-decoder neural network to tokenize time-series data to obtain a discrete-to-language embedding space;
learning, by the TSLa model, a linear mapping function by concatenating token embeddings from the discrete-to-language embedding space with positional encoding to obtain mixed-modality token sequences;
transforming the tokens from the mixed-modality token sequences with token augmentation to obtain augmented tokens;
training the TSLa model with the augmented tokens using a computed token likelihood to predict next tokens for the mixed-modality token sequences to obtain a trained TSLa model; and
fine-tuning the trained TSLa model with a domain-specific dataset to adapt the trained TSLa model to perform a domain-specific task.

2. The computer-implemented method of claim 1, wherein the domain-specific task further includes performing automated system maintenance based on system anomalies of an equipment system detected using time-series data and text data.

3. The computer-implemented method of claim 1, further comprising transforming time-series data using the trained TSLa model based on a dataset and a text instruction.

4. The computer-implemented method of claim 1, wherein training a time-series tokenizer further comprises:
segmenting, using an encoder, the time-series data into patches of a segmentation length within a continuous embedding space;
mapping outputs from the continuous embedding space into nearest discrete embeddings;
reconstructing, using an encoder, the patches based on the nearest discrete embeddings;
training the time-series tokenizer with a reconstruction loss that considers a regularized discrete embeddings and regularized patches to align parameter updates with an embedding space; and
integrating time-series data and text sequences into token sequence using a unified vocabulary of learned discrete tokens from the embedding space and text vocabulary to obtain the discrete-to-language embedding space.

5. The computer-implemented method of claim 1, wherein fine-tuning the TSLa model further comprises generating instruction templates for domain-specific tasks using a task instruction, and a modality input.

6. The computer-implemented method of claim 5, wherein fine-tuning the TSLa model further comprises adapting a frozen trained TSLa with update metrics through low-rank decomposition using the instruction templates.

7. The computer-implemented method of claim 1, wherein fine-tuning the TSLa model further comprises adapting a frozen trained TSLa with update metrics through low-rank decomposition using a domain-specific dataset.

8. A system for training a time-series-language (TSLa) model adapted for domain-specific tasks, comprising:
a memory device;
one or more processor devices operatively coupled with the memory device to cause one or more processor devices to:
train an encoder-decoder neural network to tokenize time-series data to obtain a discrete-to-language embedding space;
learn, by the TSLa model, a linear mapping function by concatenating token embeddings from the discrete-to-language embedding space with positional encoding to obtain mixed-modality token sequences;
transform the tokens from the mixed-modality token sequences with token augmentation to obtain augmented tokens;
train the TSLa model with the augmented tokens using a computed token likelihood to predict next tokens for the mixed-modality token sequences; and
fine-tune the TSLa model with a domain-specific dataset to adapt the TSLa model to perform a domain-specific task.

9. The system of claim 8, wherein the domain-specific task further includes performing automated system maintenance based on system anomalies of an equipment system detected using time-series data and text data.

10. The system of claim 8, further comprising to cause one or more processor devices to transform time-series data using the trained TSLa model based on a text instruction.

11. The system of claim 8, wherein to cause one or more processor devices to train a time-series tokenizer further comprises:
segmenting, using an encoder, the time-series data into patches of a segmentation length within a continuous embedding space;
mapping outputs from the continuous embedding space into nearest discrete embeddings;
reconstructing, using an encoder, the patches based on the nearest discrete embeddings;
training the time-series tokenizer with a reconstruction loss that considers a regularized discrete embeddings and regularized patches to align parameter updates with an embedding space; and
integrating time-series data and text sequences into token sequence using a unified vocabulary of learned discrete tokens from the embedding space and text vocabulary to obtain the discrete-to-language embedding space.

12. The system of claim 8, wherein to cause one or more processor devices to fine-tune the TSLa model further comprises generating instruction templates for domain-specific tasks using a task instruction, and a modality input.

13. The system of claim 12, wherein to cause one or more processor devices to fine-tune the TSLa model further comprises adapting a frozen trained TSLa with update metrics through low-rank decomposition using the instruction templates.

14. The system of claim 12, wherein to cause one or more processor devices to fine-tune the TSLa model further comprises adapting a frozen trained TSLa with update metrics through low-rank decomposition using a domain-specific dataset.

15. A non-transitory computer program product comprising a computer-readable storage medium including program code for training a time-series-language (TSLa) model adapted for domain-specific tasks, wherein the program code when executed on a computer causes the computer to:
train an encoder-decoder neural network to tokenize time-series data to obtain a discrete-to-language embedding space;
learn, by the TSLa model, a linear mapping function by concatenating token embeddings from the discrete-to-language embedding space with positional encoding to obtain mixed-modality token sequences;
transform the tokens from the mixed-modality token sequences with token augmentation to obtain augmented tokens;
train the TSLa model with the augmented tokens using a computed token likelihood to predict next tokens for the mixed-modality token sequences; and
fine-tune the TSLa model with a domain-specific dataset to adapt the TSLa model to perform a domain-specific task.

16. The non-transitory computer program product of claim 15, wherein the domain-specific task further includes performing automated system maintenance based on system anomalies of an equipment system detected using time-series data and text data.

17. The non-transitory computer program product of claim 15, wherein to cause the computer to train a time-series tokenizer further comprises:
segmenting, using an encoder, the time-series data into patches of a segmentation length within a continuous embedding space;
mapping outputs from the continuous embedding space into nearest discrete embeddings;
reconstructing, using an encoder, the patches based on the nearest discrete embeddings;
training the time-series tokenizer with a reconstruction loss that considers a regularized discrete embeddings and regularized patches to align parameter updates with an embedding space; and
integrating time-series data and text sequences into token sequence using a unified vocabulary of learned discrete tokens from the embedding space and text vocabulary to obtain the discrete-to-language embedding space.

18. The non-transitory computer program product of claim 15, wherein to cause the computer to fine-tune the TSLa model further comprises generating instruction templates for domain-specific tasks using a task instruction, and a modality input.

19. The non-transitory computer program product of claim 18, wherein to cause the computer to fine-tune the TSLa model further comprises adapting a frozen trained TSLa with update metrics through low-rank decomposition using the instruction templates.

20. The non-transitory computer program product of claim 15, wherein to cause the computer to fine-tune the TSLa model further comprises adapting a frozen trained TSLa with update metrics through low-rank decomposition using a domain-specific dataset.
